(19) United States
(12) Patent Application Publication
(10) Pub. No.: US 2018/0216614 A1
(43) Pub. Date: Aug. 2, 2018

(54) SCREW PUMP

(71) Applicant: DENSO CORPORATION, Kariya-city, Aichi-pref. (JP)

(72) Inventors: Yusuke HONGO, Kariya-city (JP); Masahiro OKAJIMA, Kariya-city (JP); Masashi INOUE, Nishio-city (JP); Yasuhiro TAKEUCHI, Nishio-city (JP); Haruo KAMIYA, Nishio-city (JP)

(21) Appl. No.: 15/749,812

(22) PCT Filed: Jun. 29, 2016
(86) PCT No.: PCT/JP2016/003112

§ 371 Date: Feb. 2, 2018

(30) Foreign Application Priority Data
Aug. 31, 2015 (JP) 2015-170680

(51) Int. Cl. F04C 2/16; F16C 17/10; F16C 17/20

(52) U.S. Cl. CPC F04C 2/16; F16C 17/20; F16C 17/10

(57) ABSTRACT

A screw pump pumps a fluid from an inlet port to a discharge port by rotating one drive screw and at least one driven screw which mesh with each other and includes the drive screw being rotatable about a drive rotation shaft, the driven screw to be driven by the drive screw and being rotatable about a driven rotation shaft, a drive journal provided coaxially with the drive screw and to rotate integrally with the drive screw, a driven journal provided coaxially with the driven screw and to rotate integrally with the driven screw while making contact with the drive journal along a contact line between the drive rotation shaft and the driven rotation shaft, a case including a cylinder that receives the drive screw and the driven screw, and a bearing member to rotatably support the drive journal and the driven journal.

### CROSS REFERENCE TO RELATED APPLICATION

This application is based on Japanese Patent Application No. 2015-170680 filed on Aug. 31, 2015, the disclosure of which is incorporated herein by reference.

### TECHNICAL FIELD

The present disclosure relates to a screw pump which pumps a fluid by rotating a screw.

### BACKGROUND ART

A fluid pump in the related art pumps a fluid by rotationally driving an impeller or the like. For example, a water pump disclosed in Patent Literature 1 pumps a coolant by rotating an electric motor and thereby rotationally driving an impeller attached to a rotor of the electric motor. The rotor is rotatably supported on a casing at both ends in an axial direction via dynamic bearings.

### PRIOR ART LITERATURES

### Patent Literature

Patent Literature 1: JP2003-328986A

### SUMMARY OF INVENTION

In the water pump of Patent Literature 1, one rotor is supported on sliding bearings in a rotatable manner. Besides an impeller pump, a structure of the sliding bearings is also applicable to a screw pump which pumps a fluid by rotating a male screw and a female screw in mesh with each other. However, when the structure of Patent Literature 1 is merely applied to a screw pump, an outcome is a simple configuration in which a sliding bearing is provided only to a drive screw (for example, a male screw) and no bearing is provided to a driven screw (for example, a female screw).

In the screw pump of such a configuration, a position of the driven screw is determined by meshing with the drive screw. Hence, a meshing contact force and a fluid pressure give rise to vibrations and friction is produced due to vibration contact between the drive screw and the driven screw. In addition, because a position of the driven screw is not settled, leakage of pumped fuel increases, which may possibly deteriorate pump efficiency.

It is an object of the present disclosure is to provide a screw pump reducing friction between a drive screw and a driven screw and reducing leakage.

According an aspect of the present disclosure, the screw pump pumps a fluid from an inlet port on a low-pressure side to a discharge port on a high-pressure side by rotating one drive screw constituted by one of a male screw and a female screw and at least one driven screw constituted by the other one of the male screw and the female screw which mesh with each other. The screw pump includes the drive screw, the driven screw, a drive journal, a driven journal, a case and a bearing member.

The drive screw is rotatable about a drive rotation shaft by a torque transmitted from a drive device. The driven screw is driven by the drive screw and is rotatable about a driven rotation shaft. The drive journal is provided coaxially with the drive screw and rotates integrally with the drive screw. The driven journal is provided coaxially with the driven screw and rotates integrally with the driven screw while making contact with the drive journal along a contact line between the drive rotation shaft and the driven rotation shaft. The case includes a cylinder that receives the drive screw and the driven screw. The bearing member rotatably supports the drive journal and the driven journal.

In contrast to the related art in which a bearing is provided only to the drive screw, the journal and the bearing member are provided not only to the drive screw but also to the driven screw in the screw pump of the present disclosure. The drive journal and the driven journal are rotatable while making contact with each other along the contact line. The drive journal and the driven journal are fluid-lubricated with a fluid flowing into a fitting clearance between the respective journals and the bearing member. A structure of a sliding bearing is thus obtained.

As the above configuration, a relative position of the driven screw to the drive screw is maintained. Hence, friction caused by vibration contact between the drive screw and the driven screw can be reduced. In addition, an area of fuel-passing clearances between the drive screw and the driven screw and between the respective screws and an inner wall of the cylinder can be maintained constant. Hence, leakage can be reduced.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic sectional view in an axial direction of a screw pump of first and second embodiments;

FIG. 2 is a sectional view of a screw of the first and second embodiments taken along the line II-II of FIG. 1;

FIG. 3 is an overall configuration view of a fuel supply system to which the screw pump of FIG. 1 is applied;

FIG. 4 is a sectional view of a journal and a bearing member of the first embodiment taken along the line IV-IV of FIG. 1;

FIG. 5 is a sectional view of a journal and a bearing member of the second embodiment taken along the line V-V of FIG. 1;

FIG. 6 is a schematic sectional view in an axial direction of a screw pump of a third embodiment;

FIG. 7 is a sectional view of a screw of the third embodiment taken along the line VII-VII of FIG. 6;

FIG. 8 is a sectional view of a journal and a bearing member of the third embodiment taken along the line VIII-VIII of FIG. 6;

FIG. 9 is a sectional view corresponding to FIG. 4 and showing a journal and a bearing member of another embodiment; and

FIG. 10 is a sectional view corresponding to FIG. 5 and showing a journal and a bearing member of still another embodiment.

### DESCRIPTION OF EMBODIMENTS

Hereinafter, screw pumps of several embodiments will be described according to the drawings. Substantially same configurations in the respective embodiments below are labelled with same reference numerals and a description is not repeated.

### First Embodiment

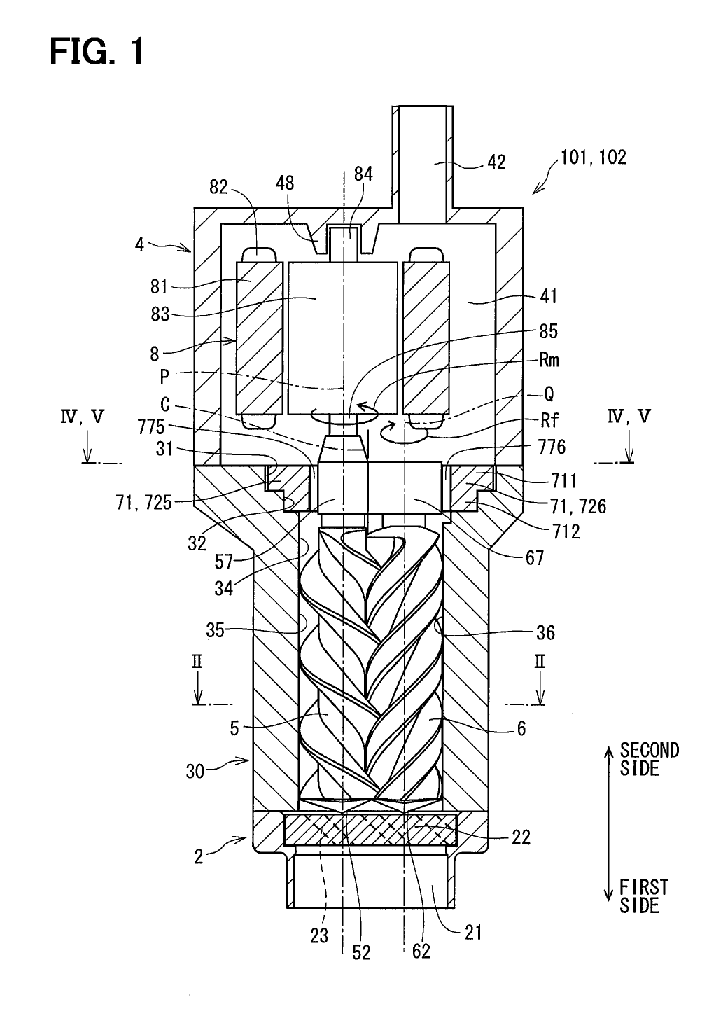

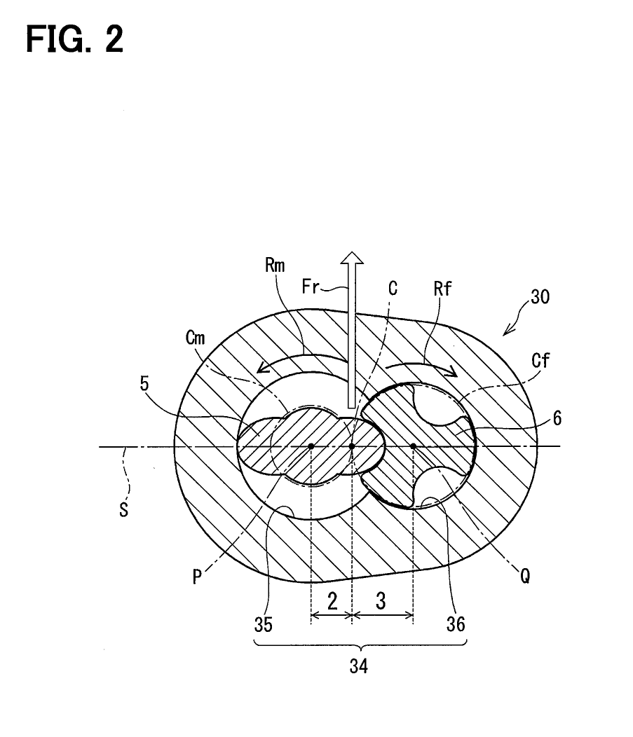

A screw pump of a first embodiment will be described with reference to FIG. 1 through FIG. 4. FIG. 1 and FIG. 2 are common in a second embodiment described below.

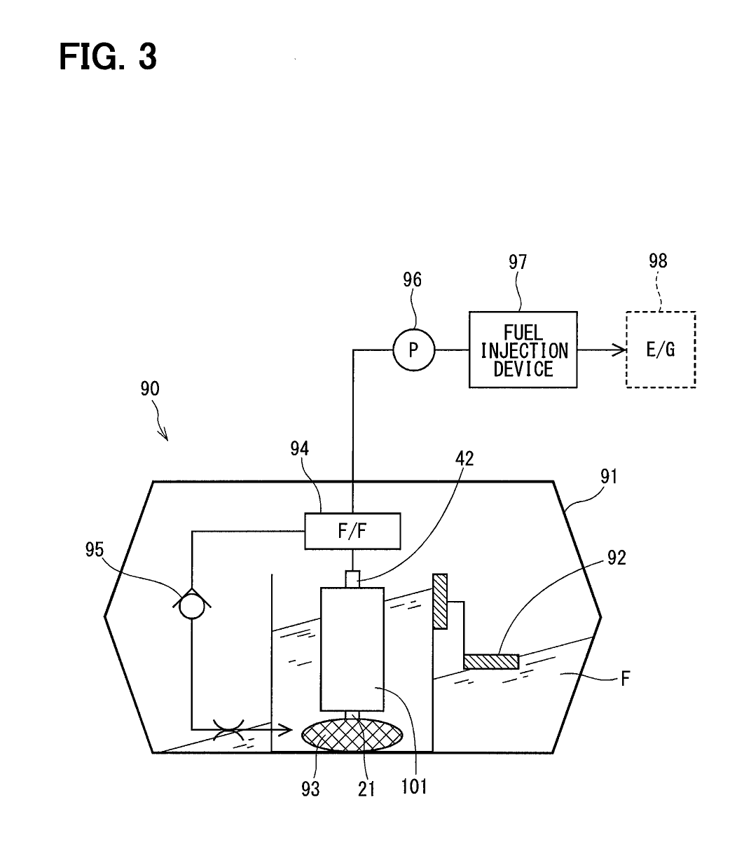

Firstly, reference is made to FIG. 3 for an overall configuration of a fuel supply system to which screw pumps of the first embodiment and the other respective embodiments below are applied. A fuel supply system 90 includes a fluid level sensor 92, a suction filter 93, a screw pump 101, a fuel filter 94, a pressure regulator 95, a high-pressure pump 96, a fuel injection device 97, and so on. The fluid level sensor 92, the suction filter 93, the screw pump 101, the fuel filter 94, and the pressure regulator 95 are provided in a fuel tank 91. The high-pressure pump 96 and the fuel injection device 97 are provided near an engine 98. The fuel supply system 90 supplies fuel F, such as gasoline, in the fuel tank 91 to the engine 98. In the drawing, a fuel filter is abbreviated to F/F and an engine is abbreviated to E/G.

The screw pump 101 draws in the fuel F in the fuel tank 91 from an inlet port 21 after the fuel F is filtered by the suction filter 93, and discharges the fuel F from a discharge port 42 after raising a pressure of the fuel F. The discharged fuel F is pumped to the high-pressure pump 96 by way of the fuel filter 94. A discharge pressure is adjusted by returning the fuel F for an extra pressure to the fuel tank 91 through the pressure regulator 95 provided to a branched path after the fuel filter 94.

The high-pressure pump 96 further raises a pressure of fuel pumped from the screw pump 101 and pumps the fuel to the fuel injection device 97. The fuel injection device 97 includes a fuel injection valve and a control device controlling fuel injection, and injects high-pressure fuel into a cylinder and an intake passage of the engine 98.

As has been described above, the screw pump 101 of the present embodiment is provided in the fuel tank 91 constituting the fuel supply system 90, and performs a function which have been performed by, for example, an impeller fuel pump in the related art.

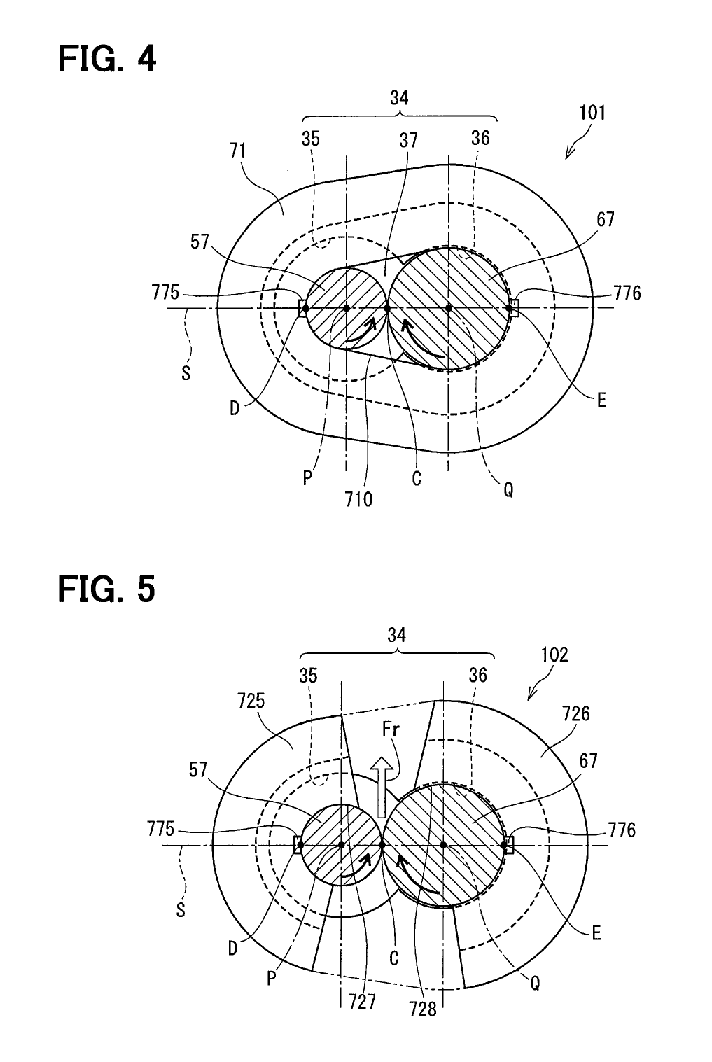

Reference is made to FIG. 1, FIG. 2, and FIG. 4 for a configuration of the screw pump.

As is shown in FIG. 1, the screw pump 101 includes a lower cover 2, a case 30, an upper cover 4, a male screw 5, a female screw 6, a male journal 57, a female journal 67, a bearing member 71, a motor 8 as a drive device, and so on.

The male screw 5 of the present embodiment corresponds to a drive screw rotatable by a torque transmitted from the motor 8. The female screw 6 of the present embodiment corresponds to a driven screw driven to rotate by the drive screw.

The male journal 57 corresponds to a drive journal provided coaxially with the male screw 5 to rotate integrally with the male screw 5. The female journal 67 corresponds to a driven journal provided coaxially with the female screw 6 to rotate integrally with the female screw 6.

In the following, the male screw 5 and the female screw 6 are referred to collectively also as the screws 5 and 6, and the male journal 57 and the female journal 67 are referred to collectively also as the journals 57 and 67.

A configuration of the screw pump common in the respective embodiments will be described first.

The male screw 5 is driven to rotate about a drive rotation shaft P in a rotation direction Rm, which is a counterclockwise direction when viewed from the motor 8. The female screw 6 driven by the male screw 5 rotates about a driven rotation shaft Q in a rotation direction Rf, which is a clockwise direction when viewed from the motor 8.

In the male screw 5, crests are narrower than roots whereas crests are wider than roots in the male screw 6. The crests of the female screw 6 mesh with the roots of the male screw 5. In the present embodiment, the male screw 5 is a double thread screw and the female screw 6 is a triple thread screw.

When the male screw 5 and the female screw 6 rotate in mesh with each other, the screw pump 101 raises a pressure of low-pressure fuel drawn in from the inlet port 21 and discharges the fuel from the discharge port 42. Regarding directions specified by a phrase, “a first side and a second side in the axial direction of the screw pump 101”, referred to in the following, the first side of FIG. 1 is faced toward the inlet port 21, and the second side of FIG. 1 is faced toward the discharge port 42. The first side corresponds to a low-pressure side and the second side corresponds to a high-pressure side of a fuel pressure.

The lower cover 2 has the inlet port 21 opening at one end and includes a backup plate 22 between the case 30 and the inlet port 21. The backup plate 22 supports a tip end 52 of the male screw 5 and a tip end 62 of the female screw 6. The backup plate 22 includes an inlet passage 23 allowing the inlet port 21 and a cylinder 34 in the case 30 to communicate.

The cylinder 34 in which to receive the screws 5 and 6 penetrates through the case 30 in the axial direction. In a radial cross section of FIG. 2, the cylinder 34 includes a first storage portion 35 in which to receive the male screw 5 and a second storage portion 36 in which to receive the female screw 6, which are connected in a peanut shell shape. A virtual plane including the drive rotation shaft P and the driven rotation shaft Q and corresponding to a symmetry plane of the peanut shell shape is given as a reference plane S.

A virtual straight line passing an intersection of a pitch circle Cm of the male screw 5 and a pitch circle Cf of the female screw 6 and parallel to the drive rotation shaft P and the driven rotation shaft Q is given as a contact line C. The contact line C passes a point at which an interval between the drive rotation shaft P and the driven rotation shaft Q is internally divided by a ratio of the number of threads of the male screw 5 to the female screw 6. When the male screw 5 is a double tread screw and the female screw 6 is a triple thread screw, the contact line C passes a point at which the interval between the drive rotation shaft P and the driven rotation shaft Q is internally divided by a ratio of two to three.

The upper cover 4 includes a discharge chamber 41 in which to store fuel fed from a communication path (first storage portion) 35, and the discharge port 42 from which to discharge fuel in the discharge chamber 41 to an outside. The motor 8 is provided inside the upper cover 4.

The motor 8 has a stator 81 and a rotor 83. A coil 82 is wound around the stator 81 and generates a rotating field. The rotor 83 has N poles and S poles of permanent magnets disposed alternately in a circumferential direction, and rotates in response to the rotating field generated by the stator 81. An end of a shaft of the rotor 83 on a side of the discharge port 42 is rotatably supported on a shaft holding portion 48 of the upper cover 4. An output shaft 85, which is an end of the shaft of the rotor 83 on a side of the inlet port 21, is coupled to the male screw 5. A torque of the motor 8 is transmitted from the output shaft 85 to the male screw 5.

A radial load generated when fuel is pumped will now be described with reference to FIG. 2.

In a portion near the contact line C where the male screw 5 and the female screw 6 mesh with each other, an upper side of the reference plane S in FIG. 2 is a front side in a rotation direction and a lower side in FIG. 2 is a rear side in the rotation direction. Given that fuel flows at a same height in the axial direction, then a pressure of fuel flowing on the roots on the rear side in the rotation direction is higher than a pressure of fuel flowing on the roots on the front side in the rotation direction, and a radial load Fr is generated from the rear side to the front side in the rotation direction in the portion near the contact line C.

A pressure of pumped fuel is relatively low on the inlet side and relatively high on the discharge side. Hence, the radial load Fr rises toward the discharge port 42. Due to such a pressure distribution, the male screw 5 and the female screw 6 are forced to incline in a direction of the radial load Fr, respectively, about the tip end 52 and the tip end 62 as supporting points.

Friction may possibly be produced when the screws 5 and 6 collide with each other or the screws 5 and 6 make contact with an inner wall of the cylinder 34 due to the radial load Fr and vibrations generated when the screw pump 101 is in operation. In addition, leakage may occur due to a variance in area of a fuel-passing clearance.

According to a technique in the related art disclosed in, for example, Patent Literature 1 (JP2003-328986A), it is anticipated that a sliding bearing is provided only to the male screw 5 in a drive region. When configured in such a manner, a position of the female screw 6 in a driven region is determined by meshing with the male screw 5. Hence, a meshing contact force and a fluid pressure give rise to vibrations, and friction is produced as well due to vibration contact between the male screw 5 and the female screw 6. Because the position of the female screw 6 is not settled, an area of a fuel-passing clearance varies. Consequently, leakage of pumped fuel increases, which may possibly deteriorate pump efficiency.

By contrast, in the screw pump 101 of the first embodiment, the journals 57 and 67 and the bearing member 71 are provided not only to the male screw 5 in the drive region but also to the female screw 6 in the driven region. A configuration of a sliding bearing adopted herein is to rotatably support outer peripheral walls of the drive and driven journals 57 and 67 by the bearing member 71 while the drive and driven journals 57 and 67 are fluid-lubricated.

A characteristic configuration of the screw pump 101 of the first embodiment will now be described.

The journals 57 and 67 are made of a steel material, for example, high carbon-chromium bearing steel.

As has been described, the male journal 57 is provided coaxially with the male screw 5 to rotate integrally with the male screw 5, and the female journal 67 is provided coaxially with the female screw 6 to rotate integrally with the female screw 6. The male journal 57 and the female journal 67 are of a cylindrical shape and the outer peripheral walls make contact with each other along the contact line C. A ratio of diameters of the male journal 57 to the female journal 67 is two to three, which is a ratio of the number of threads of the male screw 5 to the female screw 6.

A clearance between the respective journals 57 and 67 and the inner wall of the cylinder 34 is set to several μm and the respective journals 57 and 67 are fluid-lubricated when fuel flows in.

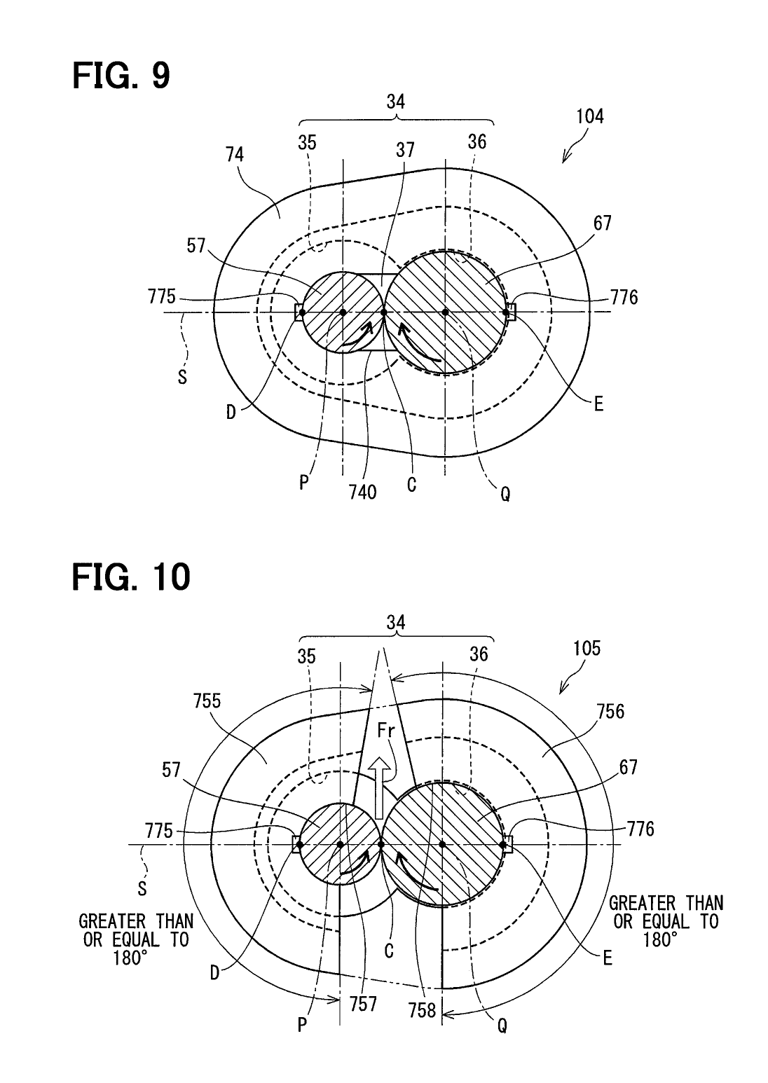

A reference is now made to FIG. 4. For ease of illustration, an outward appearance of the bearing member 71 and cross sections of the journals 57 and 67 are shown. It should be appreciated, however, that end faces of the journals 57 and 67 on the side of the motor 8 are not necessarily located closer to the motor 8 than is an end face of the bearing member 71. An end face of the case 30 that otherwise appears on a periphery of the bearing member 71 is not shown in FIG. 4. The same applies to FIG. 5, FIG. 9, and FIG. 10 referred to below.

In the first embodiment, as is shown in FIG. 4, the single bearing member 71 that is configured to commonly support the male journal 57 and the female journal 67 is provided separately from the case 30. The bearing member 71 of such a configuration is called a common bearing member. An inner peripheral wall of the bearing member 71 on the first side from the contact line C supports substantially half the outer peripheral wall of the male journal 57 in the circumferential direction. Also, the inner peripheral wall of the bearing member 71 on the second side from the contact line C supports substantially half the outer peripheral wall of the female journal 67 in the circumferential direction.

More specifically, an inner periphery of the bearing member 71 is shaped by linking an outer peripheral circle of the male journal 57 to an outer peripheral circle of the female journal 67 with a common external tangent 710. A portion enclosed by the outer peripheral circle of the male journal 57, the outer peripheral circle of the female journal 67, and the common external tangent 710 and communicating with the cylinder 34 defines a journal passage (passage between journals) 37.

The outer peripheral wall of the male journal 57 on an opposite side to the contact line C is denoted as an outermost peripheral wall D, and the outer peripheral wall of the female journal 67 on an opposite side to the contact line C is denoted as an outermost peripheral wall E. For ease of illustration, the outermost peripheral walls D and E are represented by points D and E in FIG. 4. It should be appreciated, however, that the outermost peripheral walls D and E are understood not as points in a sectional view but as predetermined regions having a width in the circumferential direction.

Side passages 775 and 776 are provided, respectively, to a portion facing the outermost peripheral wall D of the male journal 57 and a portion facing the outermost peripheral wall E of the female journal 67. The side passages 775 and 776 directly allow communication between the cylinder 34 and the discharge chamber 41. Hence, the side passages 775 and 776 communicate with the inlet port 21 and the discharge port 42.

Pumped fuel flows by passing the journal passage 37 and the side passages 775 and 776 to be discharged. Basically, the side passages 775 and 776 are secondary channels. However, by adjusting a ratio of areas of the respective passages, a distribution ratio of a flow rate can be adjusted.

As is shown in FIG. 1, in an opening of the cylinder 34 on the side of the motor 8 and on an outside of the inner periphery of the cylinder 34, a first storage hole 31 and a second storage hole 32 one size smaller than the first storage hole 31 are provided in a step shape.

The bearing member 71 that is an annular shape includes a flange portion 711 and a press-fit portion 712 in a step shape in the axial direction. By press-fitting the press-fit portion 712 into the second storage hole 32, the bearing member 71 is positioned with respect to the case 30, in particular, to the cylinder 34. The flange portion 711 is inserted into the first storage hole 31 and fitted with clearance.

### Advantages

Advantages of the screw pump 101 of the first embodiment configured as above will now be described.

(1) In the configuration of the related art in which bearings are provided only to the male screw 5 in the drive region, a shaft position of the female screw 6 in the driven region is not maintained. The shaft of the female screw 6 may be independently supported at a base end. However, it is still difficult to secure a relative position of the female screw 6 with respect to the male screw 5 with high accuracy.

By contrast, in the first embodiment, the journals 57 and 67 are rotatably supported on the bearing member 71, respectively, on the both sides of the male screw 5 and the female screw 6. It should be noted that the bearing member 71 is positioned with respect to the cylinder 34 in which the screws 5 and 6 are received.

Owing to the configuration as above, a relative position of the female screw 6 to the male screw 5 is maintained. Hence, friction caused by vibration contact between the screws 5 and 6 can be reduced. In addition, an area of fuel-passing clearances between the screws 5 and 6 and between the respective screws 5 and 6 and the inner wall of the cylinder 34 can be maintained constant. Hence, leakage can be reduced.

(2) In the first embodiment, the male journal 57 and the female journal 67 are of a cylindrical shape and the outer peripheral walls make contact with each other along the contact line C. Also, a ratio of diameters of the male journal 57 to the female journal 67 is set to two to three, which is a ratio of the number of threads of the male screw 5 to the female screw 6. Hence, the journals 57 and 67 are of a simple shape and easily machined. Accuracy in dimension and accuracy in surface roughness can be thus ensured. Consequently, positions of the screws 5 and 6 can be settled more securely by eliminating slip between the screws 5 and 6.

(3) In the first embodiment, the side passages 775 and 776 communicating with the inlet port 21 and the discharge port 42 are provided, respectively, to a portion facing the outermost peripheral wall D of the male journal 57 and a portion facing the outermost peripheral wall E of the female journal 67. A force in a direction heading to the contact line C acts on the male journal 57 and the female journal 67 due to a pressure of pumped fuel flowing in the side passages 775 and 776 to be discharged. Hence, a relative position of the female screw 6 to the male screw 5 can be maintained by bringing the male journal 57 and the female journal 67 into contact with each other in a more reliable manner.

(4) In the first embodiment, the bearing member 71 is provided separately from the case 30. Hence, the cylinder 34 can be readily provided to penetrate through the case 30, that is, the case 30 is easily machined. The bearing member 71 is also easily machined while ensuring accuracy of the inner periphery of a bearing portion and the outer periphery of the press-fit portion 712.

(5) In the first embodiment, the single common bearing member 71 that is configured to commonly support the male journal 57 and the female journal 67 is provided. When the bearing member 71 is machined, accuracy in shaft position of the arc inner wall supporting the male journal 57 and the female journal 67, accuracy in inner diameter dimension, and accuracy in roundness are particularly crucial. However, by machining the common bearing member 71 out of a single material, such crucial accuracy in machining can be readily ensured.

In the first embodiment of the present disclosure, the male journal 57 and the female journal 67 are of a cylindrical shape and the outer peripheral walls make contact with each other along the contact line. A ratio of diameters of the male journal to the female journal is set to be equal to a ratio of the number of threads of the male screw 5 to the female screw 6. In such a case, it is preferable to provide the bearing member 71 separately from the case 30.

### Second Embodiment

A screw pump of a second embodiment will be described with reference to FIG. 5. A screw pump 102 of the second embodiment is different from the counterpart of the first embodiment above in that a bearing member 725 on a side of the male journal 57 and a bearing member 726 on a side of the female journal 67 are provided in isolation. The bearing members 725 and 726 of such a configuration are called isolated bearing members.

The bearing member 725 supports an outer peripheral wall of the male journal 57 on a side opposite to a contact line C. The bearing member 726 supports an outer peripheral wall of the female journal 67 on a side opposite to the contact line C. The bearing member 725 and the bearing member 726 are provided oppositely to each other with the contact line C in between.

The bearing member 725 corresponds to a drive bearing member and the bearing member 726 corresponds to a driven bearing member.

On a front side in a rotation direction, inner peripheral portions 727 and 728 of the bearing members 725 and 726, respectively, extend in a direction nearing the contact line C. That is, the bearing members 725 and 726 are provided asymmetric with respect to a reference plane S. Such a configuration allows the bearing members 725 and 726 to suitably receive a radial load Fr acting on the front side in the rotation direction.

The bearing members 725 and 726 are provided, respectively, with the side passages 775 and 776 same as the counterparts of the first embodiment above.

As has been described, in the second embodiment, the journals 57 and 67 are supported intensively on a side in high need of support in a circumferential direction by using the isolated bearing members 725 and 726, respectively. Owing to the configuration as above, a total of volumes of the two bearing members 725 and 726 can be smaller than a volume of the bearing member 71. Hence, a product weight can be reduced. In addition, a material size can be reduced.

Further, the second embodiment can achieve advantages same as the advantages (1) through (4) of the first embodiment above.

### Third Embodiment

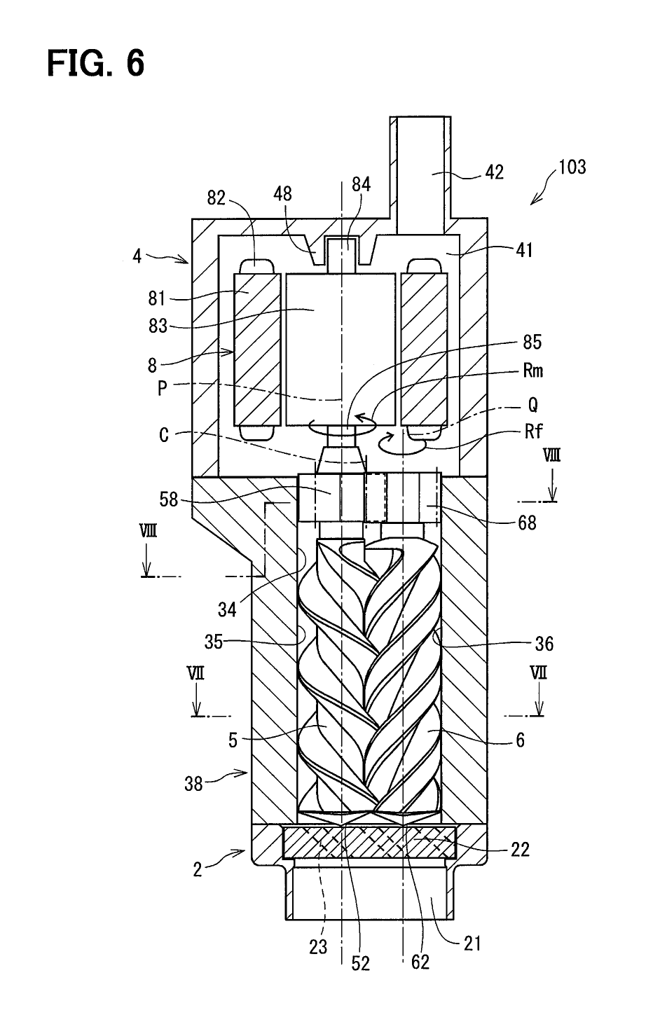

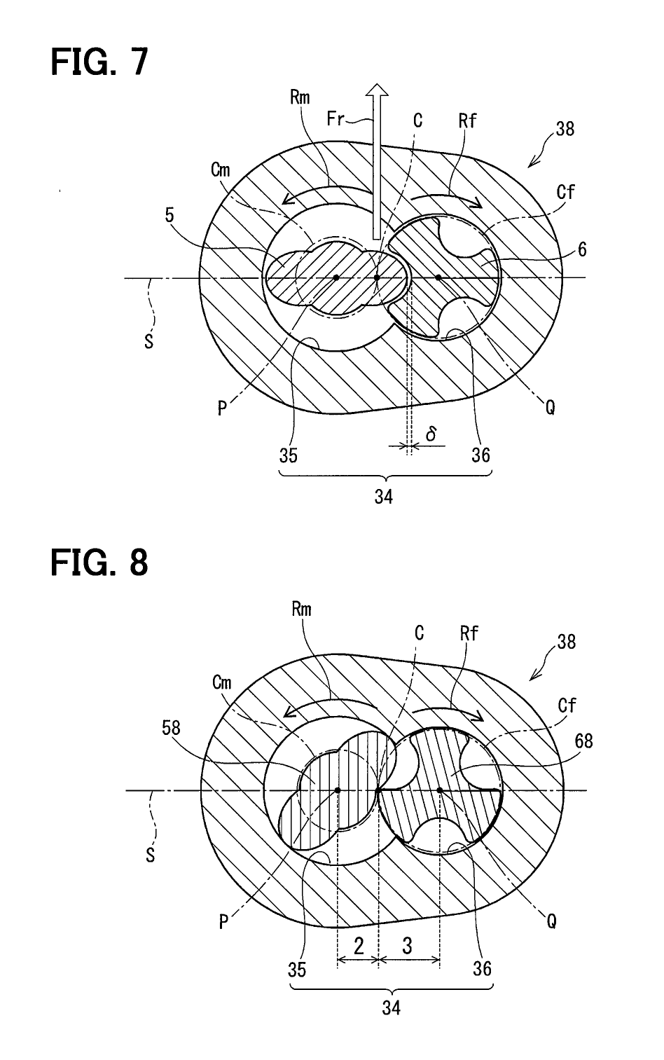

A screw pump of a third embodiment will be described with reference to FIG. 6 through FIG. 8. FIG. 6 and FIG. 7 correspond, respectively, to FIG. 1 and FIG. 2 common in the first and second embodiments above. FIG. 8 corresponds to FIG. 4 of the first embodiment above or FIG. 5 of the second embodiment above.

A screw pump 103 of the third embodiment is different from the counterparts of the first and second embodiments above in shapes of a male journal and a female journal. The screw pump 103 of the third embodiment is different in that an independent bearing member is not required and a cylinder in a case functions also as the bearing member. A male journal 58 and a female journal 68 of the third embodiment correspond to a drive journal and a driven journal, respectively.

As is shown in FIG. 8, shapes of the male journal 58 and the female journal 68 in radial cross section are same as shapes, respectively, of the male screw 5 and the female screw 6 in radial cross section shown in FIG. 7. That is, the male journal 58 and the female journal 68 are of pillar shapes meshed with each other and defined by moving the shapes of the male screw 5 and the female screw 6 in radial cross section in a direction parallel to an axial direction, respectively.

A contact line C is set on pitch circles Cm and Cf. It is obvious from FIG. 8 that the male journal 58 and the female journal 68 are not constantly in contact with each other on the contact line C during rotation, and make contact with each other intermittently depending on a rotation angle. Contact in the manner as above is also understood as “rotating while making contact along the contact line C”.

A case 38 includes the cylinder 34 in which to receive the male screw 5 and the female screw 6, and also functions as a bearing member. In short, the bearing member is provided integrally with the case 38 where the cylinder 34 is provided.

A portion of the case 38 functioning as the bearing member is in a same shape as an inner peripheral shape of the cylinder 34. In other words, a portion of the cylinder 34 on a mouth side rotatably supports outer peripheral walls of the male journal 58 and the female journal 68 as the bearing member.

In the third embedment of the present disclosure, the male journal 58 and the female journal 68 are of pillar shapes meshed with each other and defined by moving the shapes of the male screw 5 and the female screw 6 in radial cross section in a direction parallel to the axial direction, respectively, and the contact line is set on the pitch circles. The bearing member is of a same shape as the inner peripheral shape of the cylinder and provided integrally with the case 38.

The male journal 58 and the female journal 68 mesh with each other, and the male journal 58 drives the female journal 68 to rotate. Hence, the male journal 58 and the female journal 68 also function to transmit a drive torque between the screws 5 and 6. Accordingly, as is shown in FIG. 7, the male screw 5 and the female screw 6 may be provided to be rotatable without making contact with each other with a fine clearance δ in between. In the configuration as above, the fine clearance δ is maintained constant while the screws 5 and 6 are rotating.

In the third embodiment, the male journal 58 and the female journal 68 of shapes same as shapes, respectively, of the screws 5 and 6 in radial cross section rotate while making contact with each other along the contact line C. Also, the male journal 58, the female journal 68, and the inner periphery of the case 38 functioning also as the bearing member are liquid-lubricated. In short, the case 38 functions as a sliding bearing. Hence, the third embodiment achieves an advantage same as the advantage (1) of the first embodiment above.

In the third embodiment, an independent bearing member is not required and the cylinder 34 in the case 38 functions also as the bearing member. Hence, the number of components can be reduced.

For example, in the first embodiment above, the bearing member 71 is provided separately from the case 30. Hence, it is necessary to machine the press-fit portion 712 of the bearing member 71 and the second storage hole 32 of the case 30 with accuracy to position the bearing member 71 with respect to the case 30. By contrast, the bearing member is provided integrally with the case 38 in the third embodiment. Hence, a positioning configuration is not required.

In the third embodiment, by providing the male screw 5 and the female screw 6 to be rotatable without making contact with each other, friction between the screws 5 and 6 can be reduced. Also, leakage can be reduced by reducing expansion of a clearance caused by a variance in position of the screws 5 and 6.

### Other Embodiments

(A) A screw pump 104 of another embodiment shown in FIG. 9 uses a common bearing member as in the first embodiment above. However, in a common bearing member 74 shown in FIG. 9, an outer peripheral circle of the male journal 57 and an outer peripheral circle of the female journal 67 are linked with a linking line 740 on an inner side of a common external tangent. In still another embodiment, a linking line may be set on an outer side of a common external tangent. By setting a position of the linking line as needed in the above manner, a passage area of a journal passage 37 can be adjusted in response to, for example, a required flow rate.

(B) A screw pump 105 of still another embodiment shown in FIG. 10 uses isolated bearing members as in the second embodiment above. However, isolated bearing members 755 and 756 shown in FIG. 10 respectively have outer peripheral portions 757 and 758 extending in a direction nearing a contact line C on a front side in a rotation direction in comparison with the bearing members 725 and 726 of the second embodiment above. The bearing members 755 and 756 thus have a center angle greater than or equal to 180° or greater. The configuration as above allows the bearing members 755 and 756 to more suitably receive a radial load Fr acting on the front side in the rotation direction.

(C) Shapes and sizes of the side passages 775 and 776 in the first and second embodiments above are not limited to shapes and sizes specified in FIG. 4 and FIG. 5, and may be set as needed. The side passages 775 and 776 may be omitted.

(D) In the first and second embodiments above, the bearing member may be provided integrally with the case when machining is feasible.

(E) The screw pumps of the respective embodiments above include one drive screw and one driven screw. However, more than one driven screw may be provided around one drive screw in another embodiment.

(F) A female screw may be a drive screw and a male screw may be a driven screw in an opposite manner to the respective embodiments above. In such a case, a journal and a bearing member on a female screw side correspond to a drive journal and a drive bearing member, and a journal and a bearing member on a male screw side correspond to a driven journal and a driven bearing member.

(G) A drive device may be a rotating actuator operating on a hydraulic pressure, an air pressure or the like instead of the electric motor. The drive device may be provided outside of an upper cover.

(H) Configurations of the screw pump of the present disclosure as to shapes, locations, and the number of the journals and the bearing members may be changed from the configurations of the embodiments above as needed.

A fluid to which the screw pumps of the present disclosure are applied is not limited to fuel, and the present disclosure is also applicable to a liquid other than fuel and a gas, such as air.

The present disclosure is not limited to the embodiments mentioned above, and can be changed and modified to various embodiments which are also within the spirit and scope of the present disclosure.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A screw pump that pumps a fluid from an inlet port on a low-pressure side to a discharge port on a high-pressure side by rotating one drive screw constituted by one of a male screw and a female screw and at least one driven screw constituted by the other one of the male screw and the female screw which mesh with each other, the screw pump comprising:
the drive screw being rotatable about a drive rotation shaft by a torque transmitted from a drive device;
the driven screw to be driven by the drive screw and being rotatable about a driven rotation shaft;
a drive journal provided coaxially with the drive screw and to rotate integrally with the drive screw;
a driven journal provided coaxially with the driven screw and to rotate integrally with the driven screw while making contact with the drive journal along a contact line between the drive rotation shaft and the driven rotation shaft;
a case including a cylinder that receives the drive screw and the driven screw; and
a bearing member to rotatably support the drive journal and the driven journal.

2. The screw pump according to claim 1, wherein:
the drive journal and the driven journal are of a cylindrical shape and an outer peripheral wall of the drive journal and an outer peripheral wall of the driven journal make contact with each other along the contact line; and
a ratio of diameters of the drive journal to the driven journal is set to be equal to a ratio of the numbers of threads of the drive screw to the driven screw.

3. The screw pump according to claim 2, wherein:
the bearing member includes side passages, which communicate with the inlet port and the discharge port, to a portion facing the outer peripheral wall of the drive journal on an opposite side to the contact line and a portion facing the outer peripheral wall of the driven journal on an opposite side to the contact line.

4. The screw pump according to claim 2, wherein:
the bearing member is provided separately from the case.

5. The screw pump according to claim 4, wherein:
the bearing member is a single bearing member configured to commonly support the drive journal and the driven journal.

6. The screw pump according to claim 4, wherein:
the bearing member includes a drive bearing member supporting the outer peripheral wall of the drive journal on an opposite side to the contact line and a driven bearing member supporting the outer peripheral wall of the driven journal on an opposite side to the contact line, and
the drive bearing member and the driven bearing member are provided oppositely to each other.

7. The screw pump according to claim 1, wherein:
the drive journal and the driven journal are of pillar shapes meshed with each other and formed by moving shapes of the drive screw and the driven screw in radial cross section in a direction parallel to an axial direction, respectively, and the contact line is set on pitch circles; and
the bearing member is of a shape same as an inner peripheral shape of the cylinder, and provided integrally with the case.

8. The screw pump according to claim 7, wherein:
the drive screw and the driven screw are provided to be rotatable without making contact with each other.
